(19) United States
(12) Patent Application Publication
(10) Pub. No.: US 2006/0181972 A1
(43) Pub. Date: Aug. 17, 2006

(54) Disc drive apparatus, and method for recognizing cd and dvd

(76) Inventors: Aik Seng Yak, Singapore (SG); Wenhua Li, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/551,315

(22) PCT Filed: Mar. 26, 2004
(86) PCT No.: PCT/IB04/50336

§ 371 Date: Sep. 28, 2005

(30) Foreign Application Priority Data
Apr. 2, 2003 (WO) PCT/SG03/00087

(51) Int. Cl. G11B 7/00

(52) U.S. Cl. 369/44.25; 369/44.28; 369/112.01

(57) ABSTRACT

A method is described for measuring the thickness of an optical disc and determining whether the disc is a CD or a DVD. The optical lens is caused to move towards the disc with a substantially constant speed, with the optical beam switched on, and the focal error signal (FES) is analyzed. By timing the S-shaped curve (62), the actual value of said speed is determined. By timing different reflections (72, 73) from the disc, taking into account the measured speed, the thickness of the disc is determined. An important advantage is that the outcome of the thickness measurement is substantially independent from the actual value of said speed, and thus independent from the actual sensitivity of the actuator.

The present invention relates in general to a disc drive apparatus for writing/reading information into/from an optical storage disc; hereinafter, such disc drive apparatus will also be indicated as “optical disc drive”. The present invention relates further to a method for identifying the type of a disc inserted in the disc drive apparatus.

As is commonly known, optical discs have been developed according to different formats. By way of example, CD and DVD are mentioned here, but the gist of the present invention is also applicable to other disc types. Conventionally, disc drives have been developed as dedicated devices, i.e. suitable for one disc type only. Thus, for instance, optical disc drives of CD type have been developed on the one hand, and optical disc drives of DVD type have been developed on the other hand. Such dedicated disc drives are suitable for one type of optical disc only; if the wrong type of disc is inserted in such drive, the disc drive can not handle the disc and responds with an error message. In other words, such dedicated disc drives know what type of disc to expect, “wrong types” are handled according to the format of the expected disc type.

More recently, disc drives have been developed which are capable of handling two (or more) different types of disc. Such type of disc drive will be indicated as multiple-type drive. As a specific example, a multiple-type drive for handling CDs and DVDs will be described in the following, but it is to be noted that such description is not intended to restrict the protective scope of the present invention to this example since the gist of the present invention is also applicable to other types of disc.

Since a multiple-type drive may expect a disc to be any of two (or more) different types of disc, it needs to ascertain the type of disc when a new disc is inserted, in order to be able to handle the disc with the correct format.

Thus, in a multiple-type drive, there is a need for a method and apparatus for determining disc type.

An important characteristic distinguishing CDs and DVDs from each other is the thickness of the disc. A CD has a thickness of 1.2 mm whereas a DVD has a thickness of 0.6 mm. Thus, a method to recognize a CD and a DVD, or at least to distinguish between CD and DVD, has been developed on the basis of measuring the thickness of the disc: if the thickness appears to be approximately 0.6 mm (or less than a reference value, e.g. 0.9 mm) it is concluded that the disc is a DVD, whereas, if the thickness appears to be approximately 1.2 mm (or more than a reference value, e.g. 0.9 mm) it is concluded that the disc is a CD.

U.S. Pat. No. 6,061,318 discloses a method for discriminating disc type on the basis of the thickness of the disc. The focal actuator is controlled with a ramping voltage to axially displace the objective lens such that the focal point of the laser beam is axially displaced towards the disc, and the focal error signal is monitored. A characteristic of the focal error signal indicates when the focal point reaches the surface of the disc at a first moment in time, and when the focal point reaches an information layer at a second moment in time. The thickness of the disc may be calculated from the time distance between the first and the second moment in time, taking the displacement speed of the optical lens into account, which depends on the slope of the actuator driving voltage.

A problem with this prior art method is that the displacement speed of the optical lens is not accurately known, because the actuator sensitivity, i.e. displacement as a function of control voltage (mm/V), is not an accurately known constant. Typically, this sensitivity ranges from 0.65 mm/V to 1.3 mm/V. Even for one specific actuator, this sensitivity may vary with age of the actuator, and condition (e.g. temperature) of the actuator.

A main objective of the present invention is to overcome this problem.

U.S. Pat. No. 6,285,641 also discloses a method for discriminating disc type on the basis of the thickness of the disc, in a disc drive apparatus wherein the laser beam has two focal points axially displaced with respect to each other over a known distance. The focal actuator is controlled with a ramping voltage to axially displace the objective lens; the actual speed of the objective lens is determined from the time difference between two signal peaks originating from said two focal points. However, this method can only be executed if the laser beam has two focal points.

Specifically, the present invention aims to provide a more reliable disc recognition method, which is capable of being executed in a disc drive apparatus wherein the laser beam has only one focal point.

More specifically, the present invention aims to provide a disc recognition method where the dependency of the outcome on actuator sensitivity is eliminated or at least reduced.

According to an important aspect of the present invention, a method for calibrating the focal actuator is provided, wherein the time difference between the occurrence of a first characteristic feature of the focal error signal and the occurrence of a second characteristic feature of the focal error signal is taken into account. Preferably, said first characteristic feature and second characteristic feature are the maximum value and the minimum value, respectively, of the focal error signal, based on the insight that these two extremities have a fixed distance determined by the design of the optical system.

In a first special aspect, a method for measuring the speed of the focal actuator is provided.

In a second special aspect, a method for measuring the sensitivity of the focal actuator is provided.

In a third special aspect, a method for measuring the thickness of an optical disc is provided.

These and other aspects, features and advantages of the present invention will be further explained by the following description with reference to the drawings, in which same reference numerals indicate same or similar parts, and in which:

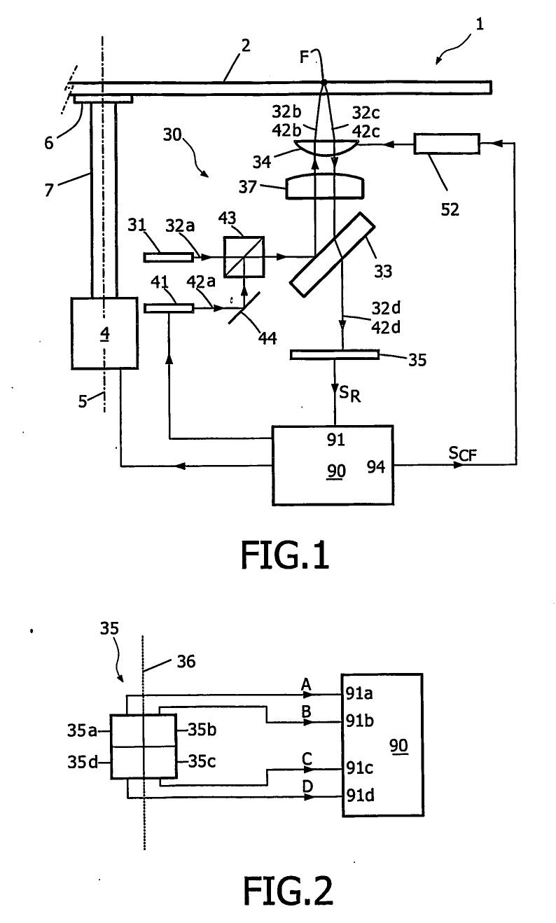

FIG. 1 schematically illustrates some relevant components of an optical disc drive apparatus;

FIG. 2 schematically illustrates an optical detector;

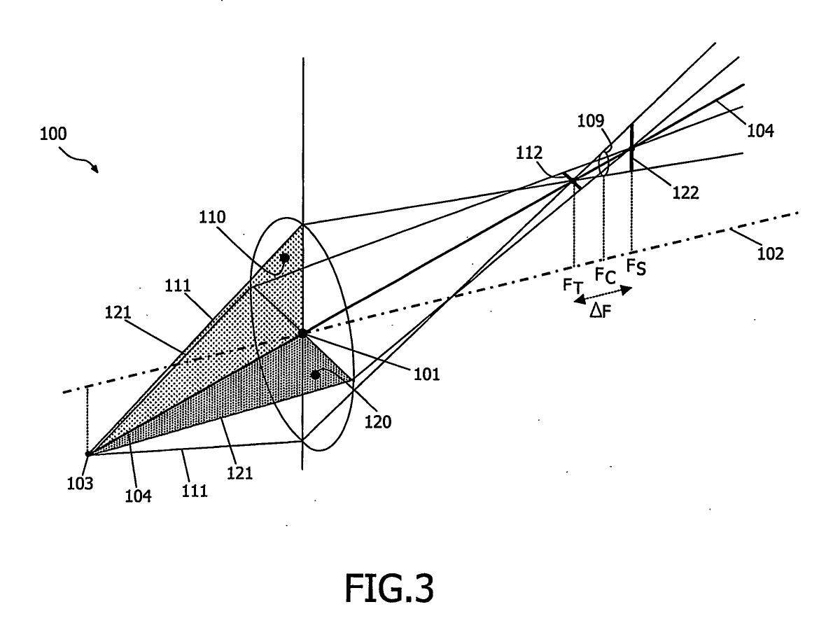

FIG. 3 schematically illustrates astigmatism;

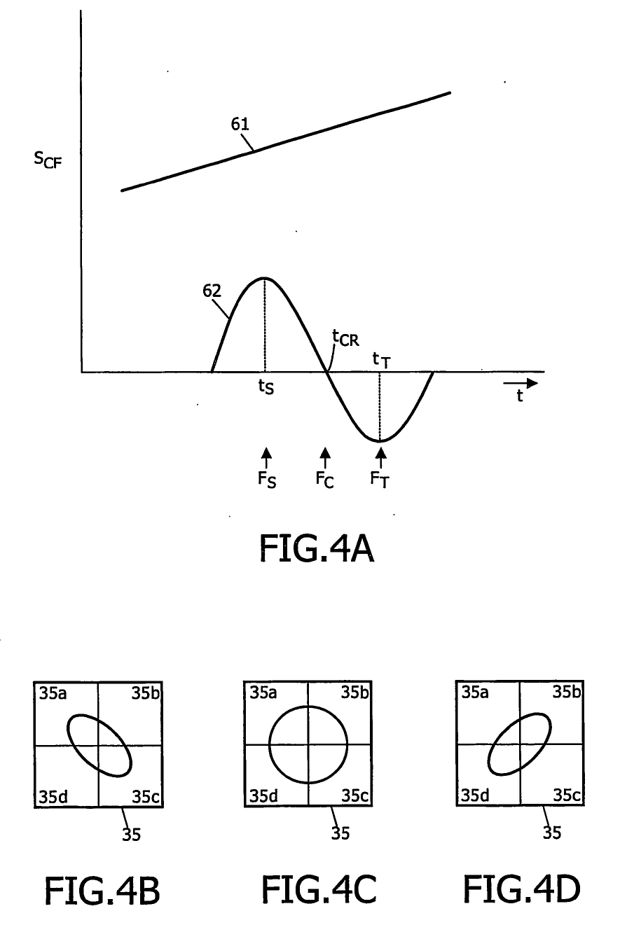

FIG. 4A schematically illustrates an S-shaped curve;

FIG. 4B-D schematically illustrate the shape of a light spot on an optical detector;

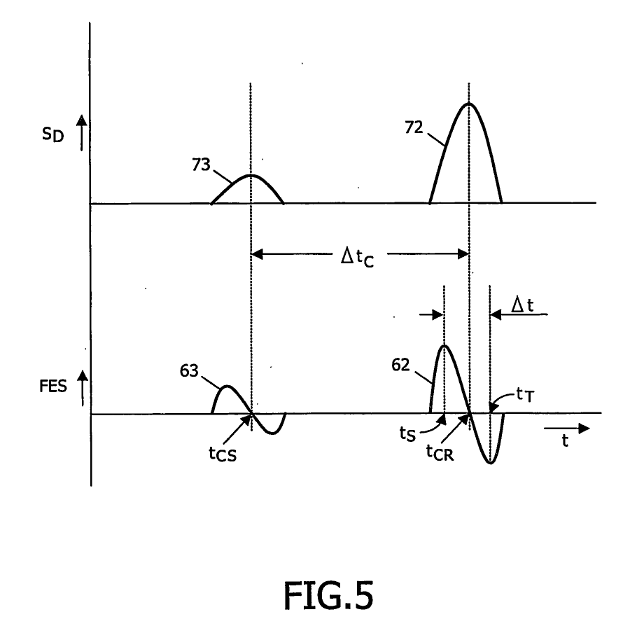

FIG. 5 schematically illustrates optical signals as a function of time.

FIG. 1 schematically illustrates an optical disc drive apparatus 1, suitable for storing information on or reading information from an optical storage disc 2, typically a DVD or a CD. The optical disc 2 comprises at least one track, either in the form of a continuous spiral or in the form of multiple concentric circles, of storage space where information may be stored in the form of a data pattern. The optical disc may be read-only type, where information is recorded during manufacturing, which information can only be read by a user. The optical disc may also be a writable type, where information may be stored by a user. Since the technology of optical discs in general, the way in which information can be stored in an optical disc, and the way in which optical data can be read from an optical disc, is commonly known, it is not necessary here to describe this technology in more detail.

For rotating the disc 2, the disc drive apparatus 1 comprises a motor 4 fixed to a frame (not shown for sake of simplicity), defining a rotation axis 5. For receiving and holding the disc 2, the disc drive apparatus 1 may comprise a turntable or clamping hub 6, which in the case of a spindle motor 4 is mounted on the spindle axle 7 of the motor 4.

The disc drive apparatus 1 further comprises an optical system 30 for scanning tracks of the disc 2 with an optical beam. More specifically, in the exemplary arrangement illustrated in FIG. 1, the disc drive apparatus 1 is a multiple-type drive designed for handling two types of disc, i.e. CD as well as DVD for example. The optical system 30 comprises a first light beam generating means 31 and a second light beam generating means 41, each typically a laser such as a laser diode, each arranged to generate a first light beam 32 and a second light beam 42, respectively. In the following, different sections of the optical path of a light beam 32, 42 will be indicated by a character a, b, c, etc added to the reference numeral 32, 42, respectively. It is noted that, in a disc drive apparatus designed for handling only one type of disc, i.e. only CD for example, typically only one laser diode will be present.

The first light beam 32 passes a first beam splitter 43, a second beam splitter 33, a collimator lens 37 and an objective lens 34 to reach (beam 32b) the disc 2. The first light beam 32b reflects from the disc 2 (reflected first light beam 32c) and passes the objective lens 34, the collimator lens 37 and the second beam splitter 33 (beam 32d) to reach an optical detector 35.

The second light beam 42 is reflected by a mirror 44, passes the first beam splitter 43, and then follows an optical path comparable with the optical path of the first light beam 32, indicated by reference numerals 42b, 42c, 42d.

The objective lens 34 is designed to focus one of the two light beams 32b, 42b in a focal spot F on an information layer (not shown for sake of simplicity) of the disc 2, which spot F normally is circular. For explaining the present invention, it will be assumed in the following that only the first laser 31 is operated and that the second laser 41 is OFF.

During operation, the light beam should remain focussed on the recording layer. To this end, the objective lens 34 is arranged axially displaceable, and the optical disc drive apparatus 1 comprises a focal actuator 52 arranged for axially displacing the objective lens 34 with respect to the disc 2. Since axial actuators are known per se, while further the design and operation of such axial actuator is no subject of the present invention, it is not necessary here to discuss the design and operation of such focal actuator in great detail.

It is noted that means for supporting the objective lens with respect to an apparatus frame, and means for axially displacing the objective lens, are generally known per se. Since the design and operation of such supporting and displacing means are no subject of the present invention, it is not necessary here to discuss their design and operation in great detail.

The disc drive apparatus 1 further comprises a control circuit 90 having an output 94 coupled to a control input of the focal actuator 52, and a read signal input 91 for receiving a read signal S_{R} from the optical detector 35. The control circuit 90 is designed to generate at its output 94 a control signal S_{CF} for controlling the focal actuator 52.

FIG. 2 illustrates that the optical detector 35 comprises a plurality of detector segments, in this case four detector segments 35a, 35b, 35c, 35d, capable of providing individual detector signals A, B, C, D, respectively, indicating the amount of light incident on each of the four detector quadrants, respectively. A centre line 36, separating the first and fourth segments 35a and 35d from the second and third segments 35b and 35c, has a direction corresponding to the track direction. Since such four-quadrant detector is commonly known per se, it is not necessary here to give a more detailed description of its design and functioning.

FIG. 2 also illustrates that the read signal input 91 of the control circuit 90 actually comprises four inputs 91a, 91b, 91c, 91d for receiving said individual detector signals A, B, C, D, respectively. The control circuit 90 is designed to process said individual detector signals A, B, C, D, in order to derive data and control information therefrom, as will be clear to a person skilled in the art. For instance, a data signal S_{D} can be obtained by summation of all individual detector signals A, B, C, D according to
S_{D}=A+B+C+D (1)
Further, a focal error signal S_{FE} can be obtained by summation of the signals A and C from one pair of individual detector segments 35a and 35c diagonally opposite to each other, summation of the signals B and D from the other pair of individual detector segments 35b and 35d diagonally opposite to each other, and taking the difference of these two summations, according to
S_{FE}=(A+C)−(B+D) (2a)
In order to compensate light intensity variations of the beam as a whole, this error signal can be normalized by division by the data signal to obtain a normalized focal error signal FES according to
FES=S_{FE}/S_{D} (2b)
The light beam 32d is subject to astigmatism. This may for instance be caused by the second beam splitter 33, which, in the example depicted in FIG. 1, is implemented as a tilted beam splitter plate. Alternatively, or additionally, it is also possible that the optical path includes an additional optical element, not shown in FIG. 1 for sake of clarity, located in front of the detector 35, for deliberately introducing astigmatism, as will be clear to a person skilled in the art. Astigmatism means that, instead of having one focal point where all light rays meet, a converging light beam has two elongate focal spots, axially displaced with respect to each other, and oriented perpendicular to each other, as illustrated in FIG. 3. FIG. 3 shows an optical system generally indicated at 100 having an optical centre 101 and an optical axis 102. An object point is indicated at 103, located at a distance from the optical axis. A principal ray 104 emerging from the object point 103 passes the optical centre 101 without refraction.

A first main plane 110, indicated as tangential plane, is defined by the optical axis 102 and the object point 103. Rays emerging from the object point 103 and located in this plane are indicated as tangential rays 111. These tangential rays 111 are refracted by the optical system 100 such as to be focused in a tangential focal spot 112.

A second main plane 120, indicated as sagittal plane, is defined by the principal ray 104 and extends perpendicular to the tangential plane. Rays emerging from the object point 103 and located in this plane are indicated as sagittal rays 121. These sagittal rays 121 are refracted by the optical system 100 such as to be focused in a sagittal focal spot 122.

Astigmatism means that the sagittal focal spot 122 does not coincide with the tangential focal spot 112. In the example of FIG. 3, the axial distance from the sagittal focal spot 122 to the optical centre 101 is larger than the axial distance from the tangential focal spot 112 to the optical centre 101. It can be shown that the axial distance between the sagittal focal spot 122 and the tangential focal spot 112 depends substantially only on optical parameters of the optical system, such as, in the case of an optical system 30 of a disc drive, the focal length of the objective lens, the focal length of the collimator lens, the refractive index of the beam splitter 33, the thickness of the beam splitter 33, the incident angle between reflected beam 32c and the beam splitter 33.

The sagittal focal spot 122, hereinafter also indicated as F_{S}, is not a point in space. It can clearly be seen from FIG. 3 that, in the sagittal focal spot F_{S}, all sagittal rays 121 are focussed but all tangential rays 111 are beyond their focal point and are diverging again, such that the sagittal focal spot F_{S} has an elongate shape. In an ideal case, the sagittal focal spot F_{S} has the shape of a line segment located in the tangential plane 110 and perpendicular to the optical axis 102.

Likewise, the tangential focal spot 112, hereinafter also indicated as F_{T}, is not a point in space. It can clearly be seen from FIG. 3 that, in the tangential focal spot F_{T}, all tangential rays 111 are focussed but all sagittal rays 121 have not yet reached their focal point and are still converging, such that the tangential focal spot F_{T} has an elongate shape. In an ideal case, the tangential focal spot F_{T} has the shape of a line segment located in the sagittal plane 120 and perpendicular to the optical axis 102.

Thus, the elongate tangential focal spot F_{T} and the elongate sagittal focal spot F_{S} are perpendicular to each other, having a fixed axial distance which will be indicated hereinafter as astigmatic focal distance ΔF. Approximately halfway between the tangential focal spot F_{T} and the sagittal focal spot F_{S}, the light beam has a substantially circular cross-section in a so-called “circle of least confusion” 109, hereinafter also indicated as circular focal point F_{C}.

FIGS. 4A-D and 5 illustrate the optical signals obtained when the focus actuator 52 displaces the objective lens 34. In FIG. 4A, the line 61 indicates a control voltage S_{CF} applied by the control circuit 90 to the focus actuator 52, and the curve 62 indicates the normalized focal error signal FES, as a function of time. As the control voltage increases, the objective lens 34 is moved towards the disc 2. Initially, the focus points F_{S} and F_{T} are well below the information layer of the disc, and the detector 35 receives only little reflected light, while further the cross-sectional shape of the optical spot on the detector 35 is more or less circular. When the sagittal focus point F_{S} approaches the information layer, FES increases, and reaches a maximum at time t_{S} when the sagittal focus point F_{S} coincides with the information layer; FIG. 4B illustrates the shape of the optical spot on the detector 35 for this situation.

With a further increase of the control voltage S_{CF}, the shape of the optical spot on the detector 35 becomes more and more circular, until at time t_{CR} the circular focal point F_{C} coincides with the information layer, FIG. 4C illustrates the circular shape of the optical spot on the detector 35 for this situation. At this moment, FES equals zero. This condition is considered to be the optimum focus condition for reading or writing optical information from/to disc, and, normally, a focus servo system is adapted to control the focus actuator to maintain the objective lens in this condition.

With a still further increase of the control voltage S_{CF}, the absolute value of FES increases again, but now FES has opposite sign because the optical spot on the detector 35 becomes elongate in another direction. At time t_{T}, FES reaches a maximum negative value, or minimum, when the tangential focus point F_{T} coincides with the information layer; FIG. 4D illustrates the shape of the optical spot on the detector 35 for this situation.

With a further increase of the control voltage S_{CF}, the absolute value of FES decreases again.

In view of its shape, curve 62 is also indicated as “S-shaped curve”.

FIG. 5 is a graph similar to FIG. 4A but on a larger time scale. This FIG. 5 shows that, at lower values of the control voltage S_{CF}, a second S-shaped curve 63 is observed, now caused by reflection of the light beam 32b by the lower surface of the disc. The time when the circular focal point F_{C} coincides with this lower disc surface, i.e. when the focal error signal FES crosses zero, is indicated as t_{CS}. Usually, the second S-shaped curve 63 corresponding with the lower disc surface has a smaller amplitude than the first S-shaped curve 62 corresponding with the information layer, as shown in FIG. 5.

FIG. 5 also shows the low frequency part of the data signal S_{D} (also known as central aperture signal CA) for the beam reflected from the lower disc surface and the beam reflected from the information layer, respectively, as curves 73 and 72, respectively. Usually, the second S_{D}-curve 73 corresponding with the lower disc surface has a smaller amplitude than the first S_{D}-curve 72 corresponding with the information layer, as shown in FIG. 5. As can be seen from FIG. 5, the S_{D}-curves 73 and 72 have maximum values at times t_{CS} and t_{CR}, respectively.

Since the astigmatic focal distance ΔF is an apparatus constant, the speed V of the optical lens 34 can be calculated from the time interval Δt=t_{T}−t_{S}, according to formula (3):
V=ΔF/Δt (3)
assuming, of course, that the speed V of the optical lens 34 is constant during said time interval.

With reference to FIG. 5, the thickness D of the disc 2, or more precisely the distance between lower disc surface and information layer, can be calculated from the speed V of the optical lens 34 and the time interval Δt_{C}=t_{CR}−t_{CS}, according to formula (4):
D=V*Δt_{C} (4)
under the assumption that the speed V of the optical lens 34 remains constant during this time interval, or at least that the average speed measured during the time interval Δt=t_{T}−t_{S} is a sufficiently accurate approximation of the average speed occurring during the time interval from t_{CS} to t_{CR}.

In a first embodiment, the control circuit 90 may calculate the duration of the time interval Δt_{C}, i.e. determine the times t_{CS} and t_{CR}, on the basis of the focal error signal FES, i.e. by determining when the zero-crossings of the focal error signal FES occur.

In a second embodiment, the control circuit 90 may calculate the duration of the time interval Δt_{C}, i.e. determine the times t_{CS} and t_{CR}, on the basis of the low frequency part of the data signal S_{D}, i.e. by determining when the peaks of the low frequency part of the data signal S_{D} occur. In this respect it is noted that determining zero-crossings may be more accurate than determining the timing of a peak, but on the other hand the second S-shaped curve 63 corresponding to the lower disc surface is very small, so that using the low frequency part of the data signal S_{D} is more convenient.

The control circuit 90 is now capable of deciding whether the disc 2 is a CD or a DVD and handling the disc in accordance with the correct format. For instance, by comparing the calculated thickness D with a suitable reference value D_{REF}, for instance D_{REF}=0.9 mm, the control circuit 90 may decide that the disc 2 is a CD if D>D_{REF} and that the disc 2 is a DVD if D<D_{REF}.

Thus, the present invention provides an improved method for measuring the thickness of an optical disc and determining whether the disc is a CD or a DVD. The optical lens 34 is caused to move towards the disc 2 with a substantially constant speed, with the optical beam 32 switched on, and the focal error signal is analyzed. By timing the S-shaped curve, the actual value of this speed V is determined. By timing different reflections from the disc, taking into account the measured speed V, the thickness of the disc is determined. An important advantage is that the outcome of the thickness measurement is substantially independent from the actual value of said speed V, and thus independent from the actual sensitivity of the actuator.

Although the present invention is intended to provide a method for a relative accurate determination of the thickness of an optical disc, and to provide a method for a reliable determination whether the disc is a CD or a DVD, an embodiment of the present invention also provides a method for measuring the speed V of the optical lens 34 (see formula 3).

Further, an embodiment of the present invention also provides a method for measuring the sensitivity γ of the actuator 52, which is defined according to formula 5:
V=γ*d(S_{CF})/dt (5)
S_{CF} being the (voltage of the) control signal from the control circuit 90 to the actuator 52. After having calculated speed V in accordance with formula 1, the control circuit 90, knowing the time-derivative of its control signal, can calculate the sensitivity γ by dividing speed V by said time-derivative according to formula 6:
γ=V/(d(S_{CF})/dt) (6)
On the other hand, if it is only desired to determine the type of disc, it is not necessary to actually calculate the speed V of the optical lens 34. By combining formulas 3 and 4, it is sufficient to calculate the actual value of a disc type parameter α, defined in accordance with formula 7:
α=Δt_{C}/Δt (7)
It is possible to determine in advance the expected value of such disc type parameter α for a CD and for a DVD. For example, if for a certain optical system the astigmatic focal distance ΔF is equal to 10 μm, then α_{CD}=120 and α_{DVD}=60. Thus, it is possible to define in advance a reference value α_{REF} for the disc type parameter α, for instance α_{REF}=90. Thus, the control circuit 90 may compare the actual value of the disc type parameter α with this reference value α_{REF}, and may decide that the disc 2 is a CD if α>α_{REF} and that the disc 2 is a DVD if α<α_{REF}.

It should be clear to a person skilled in the art that the present invention is not limited to the exemplary embodiments discussed above, but that various variations and modifications are possible within the protective scope of the invention as defined in the appending claims.

For instance, it is to be noted that the present invention is not limited to a multiple-type drive. The present invention can also be applied in a dedicated disc drive, intended for one type of disc only, to determine whether a wrong type of disc has been inserted.

Further, the present invention can likewise be used to differentiate for instance Blu-Ray discs from for instance DVD discs and CD discs.

Further, the present invention can likewise be exercised by moving the optical lens away from the disc, starting at a starting point close to the disc. Normally, however, when a new disc is inserted, or when the disc drive apparatus is switched on or initialized, the optical lens will initially be in a parking position at a relatively large distance from the disc. Nonetheless, after having measured the thickness of the disc with the method as explained above, a similar measurement can be repeated with the lens moving in the opposite direction.

In the above, a measurement for determining the speed V of the optical lens has been explained by measuring the time interval between the occurrence of two characteristic events, i.e. the maximum value and the minimum value, associated with the sagittal focal point and the tangential focal point, of one S-shaped curve only. However, as explained with reference to FIG. 5, two S-shaped curves are observed when measuring the thickness of the disc. In fact, in association with each reflective layer of the disc, respective S-shaped curves are to be expected. The speed measurement can be performed in conjunction with each of said S-shaped curves. Thus, in the example described, the speed V can be calculated for the S-curve 63 associated with the lower surface of the disc, and the speed V can also be calculated for the S-curve 62 associated with the information layer of the disc. Thus, two measuring results are obtained. It is possible that these two measuring results are compared, and that the measurements are considered as being correct only if they correspond within a certain predetermined tolerance. However, it is also possible that the average speed of the objective lens is calculated as being the mathematical average of the two measuring results, and that this average speed is used in formula 4.

In the above, the present invention has been explained by taking into account two reflections from two reflective layers, i.e. the disc surface on the one hand and an information layer on the other hand. However, it is also possible that a disc has multiple information layers. In such case, the method proposed by the present invention can likewise be exercised by taking into account the respective reflections from such information layers for determining the number and/or locations and/or mutual distances of such multiple information layers, and eventually determining the type of disc from the outcome of such determination.

In the above, the present invention has been explained by taking into account the time interval Δt_{C}=t_{CR}−t_{CS} between zero-crossings of the focal error signal. However, instead of using the zero-crossings of the focal error signal, it is also possible to use other characteristic events of the focal error signal, such as the extreme values (i.e. t_{S}, t_{T}).

In the above, the present invention has been explained by discussing a processing of the normalized focal error signal FES. Although it is preferred to use the normalized focal error signal FES, indeed, such is, however, not essential, and the present invention can also be exercised by using the non-normalized focal error signal S_{FE} according to formula 2b, because the timing of the characteristic events of this signal (i.e. maximum, minimum, zero-crossing) is not influenced by normalization.

In the above, with reference to FIG. 3, astigmatism has been explained by assuming that the focal distance of the sagittal focus point F_{S} is larger than the focal distance of the tangential focus point F_{T}. However, the same explanation applies, mutatis mutandis, if the focal distance of the sagittal focus point F_{S} is smaller than the focal distance of the tangential focus point F_{T}.

1. Method for determining axial speed (V) of an optical lens (34) of an optical disc drive (1), wherein:
a light beam (32) is generated, directed towards the optical disc (2), and caused to reflect from the optical disc (2), wherein the light beam passes said optical lens (34);
the reflected light beam (32d) is received by an optical detector (35);
an output signal (S_{R}) from said optical detector (35) is processed to derive therefrom a focal error signal (FES);
said optical lens (34) is caused to move axially with respect to said optical disc (2);
an S-shaped curve (62) of the focal error signal (FES) is timed;
and the axial speed (V) of the optical lens (34) is calculated on the basis of the timing result of the S-shaped curve (62).

2. Method according to claim 1, wherein the axial speed (V) of the optical lens (34) is calculated according to the formula:
V=ΔF/|t_{T}−t_{S}|

t_{S} being the time of occurrence of a first characteristic event of the focal error signal (FES);
t_{T} being the time of occurrence of a second characteristic event of the focal error signal (FES);
and ΔF being the spatial axial distance between two physical characteristics of said light beam (32) associated with said first and second characteristic events, respectively.

3. Method according to claim 2, wherein:
said first characteristic event is a maximum value of the focal error signal (FES);
said second characteristic event is a minimum value of the focal error signal (FES);
ΔF being the astigmatic focal distance of said light beam (32).

4. Method for determining the sensitivity (γ) of a focal actuator (52) of an optical disc drive (1), wherein:
a sloping control signal (S_{CF}) having a substantially constant slope is applied to the focal actuator (52) such as to cause an optical lens (34) to move axially with respect to an optical disc (2);
a light beam (32) is generated, directed towards the optical disc (2), and caused to reflect from an optical disc (2), wherein the light beam passes said optical lens (34);
the reflected light beam (32d) is received by an optical detector (35);
an output signal (S_{R}) from said optical detector (35) is processed to derive therefrom a focal error signal (FES);
an S-shaped curve (62) of the focal error signal (FES) is timed;
and the sensitivity (γ) of the focal actuator (52) is calculated on the basis of the timing result of the S-shaped curve (62).

5. Method according to claim 4, wherein the sensitivity (γ) of the focal actuator (52) is calculated according to the formula:
γ=ΔF/(|t_{T}−t_{S}|*d(S_{CF})/dt)
d(S_{CF})/dt being the time-derivative of the control signal S_{CF};
t_{S} being the time of occurrence of a first characteristic event of the focal error signal (FES);
t_{T} being the time of occurrence of a second characteristic event of the focal error signal (FES);
and ΔF being the spatial axial distance between two physical characteristics of said light beam (32) associated with said first and second characteristic events, respectively.

6. Method according to claim 5, wherein:
said first characteristic event is a maximum value of the focal error signal (FES);
said second characteristic event is a minimum value of the focal error signal (FES);
ΔF being the astigmatic focal distance of said light beam (32).

7. Method for determining the distance (D) between two reflective layers of an optical disc (2), wherein:
a light beam (32) is generated, directed towards the optical disc (2), and caused to reflect from the optical disc (2), wherein the light beam passes an optical lens (34);
the reflected light beam (32d) is received by an optical detector (35);
an output signal (S_{R}) from said optical detector (35) is processed to derive therefrom a focal error signal (FES);
said optical lens (34) is caused to move axially with respect to said optical disc (2);
the occurrence of characteristic events of S-shaped curves (62; 63) of the focal error signal (FES), associated with said two layers, is timed;
at least one S-shaped curve (62) of the focal error signal (FES) is timed;
and the distance (D) between said two reflective layers is calculated on the basis of the timing result of the S-shaped curve (62) on the one hand and on the other hand on the basis of the timing result of the characteristic events of said S-shaped curves (62; 63).

8. Method according to claim 7, wherein an axial speed (V) of the optical lens (34) is calculated according to the formula:
V=ΔF/|t_{T}−t_{S}|

t_{S} being the time of occurrence of a first characteristic event of said at least one S-shaped curve (62) of the focal error signal (FES);
t_{T} being the time of occurrence of a second characteristic event of the same S-shaped curve (62) of the focal error signal (FES);
and ΔF being the spatial axial distance between two physical characteristics of said light beam (32) associated with said first and second characteristic events, respectively.

9. Method according to claim 8, wherein:
said first characteristic event is a maximum value of the S-shaped curve (62) of the focal error signal (FES);
said second characteristic event is a minimum value of the same S-shaped curve (62) of the focal error signal (FES);
ΔF being the astigmatic focal distance of said light beam (32).

10. Method according to claim 8, wherein the distance (D) is calculated in accordance with the formula:
D=V*Δt_{C}
Δt_{C}=t_{CR}−t_{CS} being the time interval between said characteristic events of said two S-shaped curves (62; 63).

11. Method according to claim 10, each of said characteristic events of said two S-shaped curves (62; 63) being the zero-crossing of the corresponding S-shaped curve (62; 63).

12. Method according to claim 7, wherein the distance (D) is calculated according to the formula:
D=ΔF*Δt_{C}/|t_{T}−t_{S}|

t_{S} being the time of occurrence of a first characteristic event of said at least one S-shaped curve (62) of the focal error signal (FES);
t_{T} being the time of occurrence of a second characteristic event of the same S-shaped curve (62) of the focal error signal (FES);
ΔF being the spatial axial distance between two physical characteristics of said light beam (32) associated with said first and second characteristic events, respectively;
and Δt_{C}=t_{CR}−t_{CS} being the time interval between said characteristic events of said two S-shaped curves (62; 63).

13. Method according to claim 12, wherein:
said first characteristic event of said S-shaped curve (62) is a maximum value of this S-shaped curve (62);
said second characteristic event of the same S-shaped curve (62) is a minimum value of the same S-shaped curve (62);
ΔF being the astigmatic focal distance of said light beam (32);
and each of said characteristic events of said two S-shaped curves (62; 63) being the zero-crossing of the corresponding S-shaped curve (62; 63).

14. Method for recognizing type (CD; DVD) of an optical disc, wherein:
a light beam (32) is generated, directed towards the optical disc (2), and caused to reflect from the optical disc (2), wherein the light beam passes an optical lens (34);
the reflected light beam (32d) is received by an optical detector (35);
an output signal (S_{R}) from said optical detector (35) is processed to derive therefrom a focal error signal (FES);
said optical lens (34) is caused to move axially with respect to said optical disc (2);
the occurrence of characteristic events of S-shaped curves (62; 63) of the focal error signal (FES), associated with said two layers, is timed;
at least one S-shaped curve (62) of the focal error signal (FES) is timed;
wherein a disc type parameter (α) is calculated in accordance with the formula:
α=Δt_{C}/(t_{T}−t_{S})
t_{S} being the time of occurrence of a first characteristic event of said at least one S-shaped curve (62) of the focal error signal (FES);
t_{T} being the time of occurrence of a second characteristic event of the same S-shaped curve (62) of the focal error signal (FES);
Δt_{C}=t_{CR}−t_{CS} being the time interval between said characteristic events of said two S-shaped curves (62; 63);
wherein the measured parameter value (α) is compared with a predetermined reference value (α_{REF}), and wherein it is decided that the optical disc is of a first type (CD) if the measured parameter value is larger than said reference value (α_{REF}), and that the optical disc is of a second type (DVD) if the measured parameter value is smaller than said reference value (α_{REF}).

15. Method according to claim 14, wherein:
said first characteristic event is a maximum value of the S-shaped curve (62) of the focal error signal (FES);
said second characteristic event is a minimum value of the same S-shaped curve (62) of the focal error signal (FES);
and each of said characteristic events of said two S-shaped curves (62; 63) being the zero-crossing of the corresponding S-shaped curve (62; 63).

16. Method for determining the distance (D) between two reflective layers of an optical disc (2), wherein:
a light beam (32) is generated, directed towards the optical disc (2), and caused to reflect from the optical disc (2), wherein the light beam passes an optical lens (34);
the reflected light beam (32d) is received by an optical detector (35);
an output signal (S_{R}) from said optical detector (35) is processed to derive therefrom a focal error signal (FES) and a data signal (S_{D});
said optical lens (34) is caused to move axially with respect to said optical disc (2);
the occurrence of characteristic events of data signal curves (72; 73), associated with said two layers, is timed;
at least one S-shaped curve (62) of the focal error signal (FES) is timed;
and the distance (D) between said two reflective layers is calculated on the basis of the timing result of the S-shaped curve (62) on the one hand and on the other hand on the basis of the timing result of the characteristic events of said data signal curves (72; 73).

17. Method according to claim 16, wherein an axial speed (V) of the optical lens (34) is calculated according to the formula:
V=ΔF/|t_{T}−t_{S}|

t_{S} being the time of occurrence of a first characteristic event of said at least one S-shaped curve (62) of the focal error signal (FES);
t_{T} being the time of occurrence of a second characteristic event of the same S-shaped curve (62) of the focal error signal (FES);
and ΔF being the spatial axial distance between two physical characteristics of said light beam (32) associated with said first and second characteristic events, respectively.

18. Method according to claim 17, wherein:
said first characteristic event is a maximum value of the S-shaped curve (62) of the focal error signal (FES);
said second characteristic event is a minimum value of the same S-shaped curve (62) of the focal error signal (FES);
ΔF being the astigmatic focal distance of said light beam (32).

19. Method according to claim 17, wherein the distance (D) is calculated in accordance with the formula:
D=V*Δt_{C}
Δt_{C}=t_{CR}−t_{CS} being the time interval between said characteristic events of said data signal curves (72; 73).

20. Method according to claim 19, each of said characteristic events of said data signal curves (72; 73) being the peak of the corresponding curve (72; 73) of the low frequency part of the data signal.

21. Method according to claim 16, wherein the distance (D) is calculated according to the formula:
D=ΔF*Δt_{C}/|t_{T}−t_{S}|

t_{S} being the time of occurrence of a first characteristic event of said at least one S-shaped curve (62) of the focal error signal (FES);
t_{T} being the time of occurrence of a second characteristic event of the same S-shaped curve (62) of the focal error signal (FES);
ΔF being the spatial axial distance between two physical characteristics of said light beam (32) associated with said first and second characteristic events, respectively;
and Δt_{C}=t_{CR}−t_{CS} being the time interval between said characteristic events of said data signal curves (72; 73).

22. Method according to claim 21, wherein:
said first characteristic event of said S-shaped curve (62) is a maximum value of this S-shaped curve (62);
said second characteristic event of the same S-shaped curve (62) is a minimum value of the same S-shaped curve (62);
ΔF being the astigmatic focal distance of said light beam (32);
and each of said characteristic events of said data signal curves (72; 73) being the peak of the corresponding curve (72; 73) of the low frequency part of the data signal.

23. Method for recognizing type (CD; DVD) of an optical disc, wherein:
a light beam (32) is generated, directed towards the optical disc (2), and caused to reflect from the optical disc (2), wherein the light beam passes an optical lens (34);
the reflected light beam (32d) is received by an optical detector (35);
an output signal (S_{R}) from said optical detector (35) is processed to derive therefrom a focal error signal (FES);
said optical lens (34) is caused to move axially with respect to said optical disc (2);
the occurrence of characteristic events of data signal curves (72; 73), associated with said two layers, is timed;
at least one S-shaped curve (62) of the focal error signal (FES) is timed; wherein a disc type parameter (a) is calculated in accordance with the formula:
α=Δt_{C}/(t_{T}−t_{S})
t_{S} being the time of occurrence of a first characteristic event of said at least one S-shaped curve (62) of the focal error signal (FES);
T being the time of occurrence of a second characteristic event of the same S-shaped curve (62) of the focal error signal (FES);
t_{C}=t_{CR}−t_{CS} being the time interval between said characteristic events of said data signal curves (72; 73);
herein the measured parameter value (α) is compared with a predetermined reference value (α_{REF}), and wherein it is decided that the optical disc is of a first type (CD) if the measured parameter value is larger than said reference value (α_{REF}), and that the optical disc is of a second type (DVD) if the measured parameter value is smaller than said reference value (α_{REF}).

24. Method according to claim 23, wherein:
said first characteristic event is a maximum value of the S-shaped curve (62) of the focal error signal (FES);
said second characteristic event is a minimum value of the same S-shaped curve (62) of the focal error signal (FES);
and each of said characteristic events of said data signal curves (72; 73) being the peak of the corresponding curve (72; 73) of the low frequency part of the data signal.

25. Method for recognizing type (CD; DVD) of an optical disc, wherein the distance (D) between two reflective layers of the optical disc (2) is measured by a method in accordance with claim 7;
wherein the measured distance is compared with a predetermined reference value;
and wherein it is decided that the optical disc is of a first type (CD) if the measured distance (D) is larger than said reference value, and that the optical disc is of a second type (DVD) if the measured distance (D) is smaller than said reference value.

26. Method according to claim 25, wherein said distance (D) corresponds to the thickness of the disc, and wherein said predetermined reference value is preferably in the order of about 0.9 mm.

27. Method according to claim 7, wherein said distance (D) corresponds to the thickness of the disc.

28. Disc drive apparatus (1), designed to perform a method according to claim 1.

29. Disc drive apparatus (1), designed to perform a disc type recognition method according to claim 14;
wherein the disc drive apparatus (1) is adapted to handle one disc type only, and wherein the disc drive apparatus (1) rejects an inserted disc if the disc type recognition procedure reveals that the inserted disc is not a correct disc.

30. Disc drive apparatus (1), designed to perform a disc type recognition method according to claim 14;
wherein the disc drive apparatus (1) is adapted to handle at least two different disc types, and wherein the disc drive apparatus (1) proceeds with handling an inserted disc in accordance with the disc type as revealed by the disc type recognition procedure.
